(19) United States
(12) Patent Application Publication
(10) Pub. No.: US 2016/0233707 A1
(43) Pub. Date: Aug. 11, 2016

(54) Power Adapter with Charging Data Display

(71) Applicant: Michael Kidakarn, City of Industry, CA (US)

(72) Inventor: Michael Kidakarn, City of Industry, CA (US)

(21) Appl. No.: 15/016,798

(22) Filed: Feb. 5, 2016

Related U.S. Application Data
(60) Provisional application No. 62/112,874, filed on Feb. 6, 2015.

(51) Int. Cl. H02J 7/00

(52) U.S. Cl. CPC H02J 7/0047; H02J 7/007

(57) ABSTRACT

A power adapter with charging data display provides power to a battery of a communication device. The power adapter displays numbers and a progressive lighting system, such as LED lights, to indicate a power transfer rate, an estimated recharge time, and a completed charge time of the battery. In this manner, the charging status of the battery is made known, and the battery will not be overcharged, causing damage to the battery. A current detecting circuit detects a charging current passing through the battery, and derives a detected current signal. A voltage detecting circuit detects a charging voltage generated at the battery, and derives a detected voltage signal. Software calculates the power transfer rate, estimated recharge time, and completed charge time of the battery based on the detected voltage signal and detected current signal. A label panel includes apertures and labels that identify each of the charging data.

### CROSS REFERENCE OF RELATED APPLICATIONS

This application claims the benefits of U.S. provisional application No. 62112874 filed Feb. 6, 2015 and entitled Power Adapter with Charging Data Display, which provisional application is incorporated by reference herein in its entirety.

### FIELD OF THE INVENTION

The present invention relates generally to a power adapter with charging data display. More so, a power adapter with charging data display connects to a power source to provide power to a battery in a communication device, and through detection of the current and voltage applied to the battery, displays a power transfer rate, an estimated recharge time, and a completed charge time for the battery.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that a recharging is a process to restore power or charge to a power storage device, such as a battery. The recharger is a device used to put energy into a secondary cell or rechargeable battery by forcing an electric current through it. A power adapter

Typically, electrical devices are in abundance in everyday life. These range from small, handheld entertainment devices to operational necessities, such as computers, copiers, printers and the like. All require periodic or continuous attachment to a power source through a wall outlet.

One common solution to the above is extension cords. These are usually constructed as an elongate cord of predetermined, fixed length having an adapter end with one or more sockets. While useful, the typical extension cord limits how far one can extend the power cord, and creates a potential hazard due to unintentional tangling of the cord.

Another common solution includes power strips having a plurality of receptacles. These usually implement a protective power surge mechanism. These are also useful, since they provide the convenience of multiple, additional outlets and added protection features. However, most do not have different socket configurations for different types of electrical devices, or a means of controlling power to individual sockets, especially at a time when energy conservation is a worldwide concern.

However, most electrical devices require a battery and the battery is rechargeable in one way or the other. For example, many electrical devices are equipped with rechargeable batteries and are available with matching battery recharger units. The electrical device batteries can be recharged rather than disposed of when their energy has been depleted, thus reducing expenditures for batteries.

Generally, rechargeable batteries are used in a variety of portable electrical devices, including laptop computers, personal digital assistants (PDAs), cell phones, digital media players, cameras, etc. The rechargeable battery in such devices is typically charged using power supplied from a power adapter connected to an external power source. The power adapter may also be configured to provide power to run the device, in conjunction with charging the internal battery.

Often, the power adapter is uniquely adapted to accept a particular electrical device and to make the necessary electrical connections with the electrical device to recharge the batteries while they are still in the electrical device. Also, if the electrical device is infrequently used, it can be stored with its batteries kept at full charge. The user simply plugs the electrical device into the recharger between uses.

Typically, for proper recharging of such systems, the electrical device and power adapter must mate together in a secure electrical connection. Therefore, most conventional recharger units must be securely attached to a mounting surface so the electrical connection can be made when the electrical device is attached and detached. The need for a secure mounting reduces the mobility of the electrical device because the recharger cannot be easily transported.

For example, a power adapter and other similar recharger units are frequently mounted to a wall or to a secure bracket in a car or truck. If the electrical device is needed at a different location, the power adapter must be left behind or an additional power adapter must be obtained. The electrical device can run out of charge while it is being used at the different location if no other power adapter or recharger is available. In addition, once the electrical device batteries run out of charges, the electrical device must be plugged back into the power adapter and cannot be used.

Other proposals have involved recharging batteries and electrical devices. The problem with these rechargers id that they do not efficiently display the amount of current and voltage in the battery. Even though the above cited rechargers meets some of the needs of the market, a power adapter with charging data display connects to a power source to provide power to a battery in a communication device, and through detection of the current and voltage applied to the battery, displays a power transfer rate, an estimated recharge time, and a completed charge time for the battery is still desired.

### SUMMARY OF THE INVENTION

The present invention is directed to a power adapter with charging data display. In some embodiments, the power adapter with charging data display is configured to provides power to a battery of a communication device. The power adapter displays numbers and a progressive lighting system, such as LED lights, to indicate a power transfer rate, an estimated recharge time, and a completed charge time of the battery. In this manner, the charging status of the battery is made known, and the battery will not be overcharged, causing damage to the battery.

In another embodiment, the power adapter includes a current detecting circuit that detects a charging current passing through the battery, and derives a detected current signal. A voltage detecting circuit detects a charging voltage generated at the battery, and derives a detected voltage signal. Software calculates the power transfer rate, estimated recharge time, and completed charge time of the battery based on the detected voltage signal and detected current signal. A label panel includes apertures and labels that identify each of the charging data.

One aspect of a power adapter with recharge data display, comprises:

a power adapter, the power adapter defined by a housing, the housing having a charging end and a display end, the power adapter configured to enable recharging;

a power transfer cable, the power transfer cable configured to connect to the charging end of the housing, the power transfer cable configured to carry current from the charging end of the housing for recharging;

a current detecting circuit, the current detecting circuit configured to enable detection of a charging current during recharging;

a voltage detecting circuit, the voltage detecting circuit configured to enable detection of a charging voltage during recharging;

a processor, the processor configured to derive at least one charging data based on the charging current and the charging voltage;

a plurality of displays, the plurality of displays disposed to position on the display end of the housing, the plurality of displays configured to display the at least one charging data; and

a label panel, the label panel disposed to at least partially overlay the display end of the housing and the plurality of displays, the label panel comprising at least one label, the at least one label configured to identify the at least one charging data on the plurality of displays, the label panel further comprising a plurality of apertures, the plurality of apertures configured to enable viewing of the at least one charging data,

wherein the at least one label correlates with a respective at least one charging data.

In another aspect, the power adapter is an AC/DC wall adapter.

In another aspect, the power adapter is generally rectangular or circular shaped.

In another aspect, the power transfer cable is a USB cord.

In another aspect, the power adapter recharges a battery on a communication device.

In another aspect, the battery includes at least one member selected from the group consisting of: a lithium polymer battery, a lithium ion battery, a nickel cadmium battery, and a nickel metal hybrid battery.

In another aspect, the plurality of displays includes at least one member selected from the group consisting of: a digital screen, a seven-segment display, a touch screen, a liquid crystal display, a progressive lighting system, and a series of LED lights.

In another aspect, the plurality of apertures are configured to substantially match the shape of the plurality of displays.

In another aspect, the power adapter further comprises a switch circuit, the switch circuit configured to regulate current from a power source.

In another aspect, the at least one charging data includes at least one member selected from the group consisting of: a power transfer rate, an estimated recharge time, and a completed charge time of the battery.

In another aspect, the processor comprises an algorithm, the algorithm configured to calculate the charging data based on the detected voltage signal and detected current signal.

In another aspect, the processor comprises a timer, the timer configured to progressively indicate the rate of recharging and termination of recharging.

One objective of the present invention is to provide a power adapter that helps identify the efficiency of a recharging cable by displaying at least one charging data.

Another objective is to save money because the power adapter enables differentiation between efficient and non-efficient cables

Another objective is to provide a power adapter that is universal for charging eclectic types of communication devices, including phones.

Another objective is to provide a processor that calculates at least one charging data based on charging current and charging voltage during recharging of a communication device.

Another objective is to provide a label panel that securely fastens onto the label end of the power adapter.

Yet another objective is to provide at least one label that is indicative of each charging data.

Yet another objective is to provide an inexpensive and easy to operate power adapter that both recharges a communication device and indicates recharging data pertinent to the battery in the communication device.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The present invention is directed to a

The invention will now be described, by way of example, with reference to the accompanying drawings, in which:

FIG. 1 illustrates a frontal view of an exemplary power adapter with charging data display connected to an exemplary communication device, in accordance with an embodiment of the present invention;

FIG. 2 illustrates a perspective view of an exemplary power adapter with charging data display having a substantially rectangular shape, in accordance with an embodiment of the present invention;

FIG. 3 illustrates a perspective view of an exemplary power adapter with charging data display having a substantially circular shape, in accordance with an embodiment of the present invention;

FIG. 4 illustrates a schematic diagram of an exemplary power adapter with charging data display connected to an exemplary battery, in accordance with an embodiment of the present invention; and

FIG. 5 illustrates a block diagram depicting an exemplary client/server system which may be used by an exemplary web-enabled/networked embodiment, in accordance with an embodiment of the present invention.

Like reference numerals refer to like parts throughout the various views of the drawings.

### DETAILED DESCRIPTION OF THE INVENTION

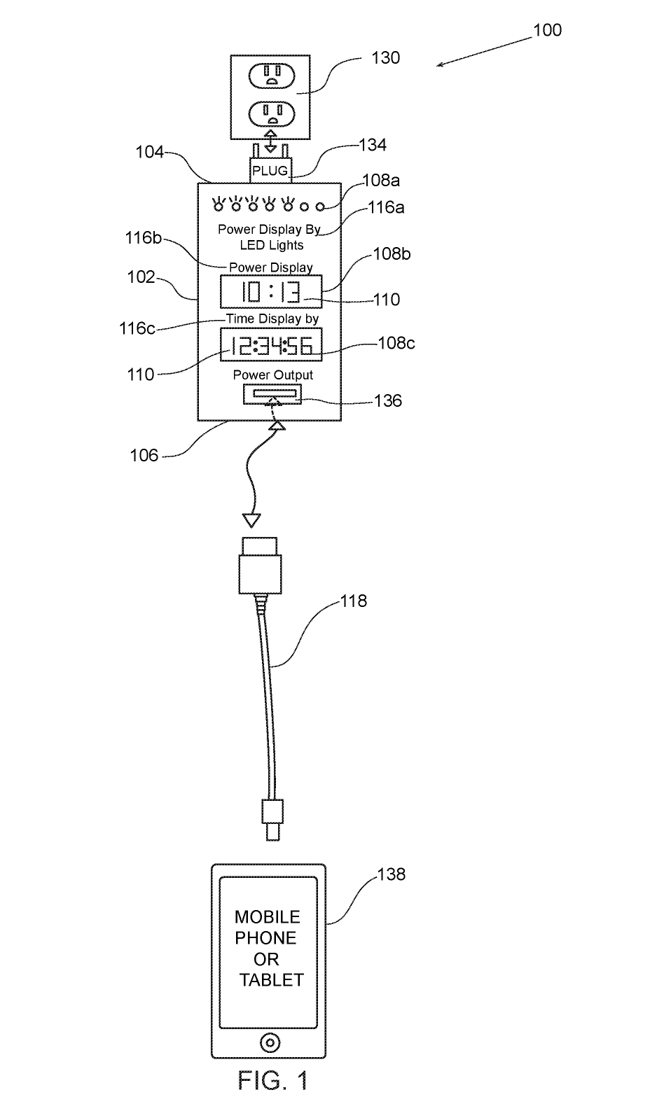

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-5, a power adapter 100 with charging data display operatively connects to a power source 130 to provide power to a battery 132 for a communication device 138. The power adapter 100 also serves to display at least one charging data 110 that is pertinent to the recharging of the battery 132. Specifically, the power adapter 100 displays numbers, progressive lighting, and a series of LEDs to indicate a power transfer rate, an estimated recharge time, and a completed charge time of the battery 132. In this manner, the charging status of the battery 132 is made known, and the battery 132 is prevented from overcharging, which may cause damage to the battery 132. Additionally, the efficiency of a power transfer cable 118, which carries power from the power adapter 100 to the battery 132, is also made known since the charging data 110 provides a reference for charging capacities and rates.

In one embodiment, the power adapter 100 includes an AC/DC wall adapter that couples to a power source 130. A power transfer cable 118, such as a USB cable, carries current form the power adapter 100 to the battery 132 in the communication device 138. The power adapter 100 comprises a current detecting circuit 120 that detects a charging current passing through the battery 132 during recharging, and derives a detected current signal therefrom. The power adapter 100 further comprises a voltage detecting circuit 122 that detects a charging voltage generated at the battery 132 during recharging, and derives a detected voltage signal therefrom. The power adapter 100 may also utilize a processor 126 having an algorithm. The algorithm is configured to calculate the charging data 110 based on the detected voltage signal and detected current signal. The algorithm may include a software program that

In one exemplary calculation of the charging data by the algorithm, a relationship exists between current and sensor output voltage. A current sensor and a voltage sensor are integrated in the housing 102. The current sensor is supplied with 8 Volts DC from an on board regulator. There is no current flow at this point, however the current sensor simply divides its supply voltage in half (8V divided by 2=4.0 Volts output). However, for every amp that flows through the wire, the voltage output from the sensor increased about 0.033 Volts. The algorithm may further use a formula to convert from Volts to Amps is as follows: Measured Current=(Vsensor−4.0)/0.033. So for example if the sensor puts out 5 Volts, then the measured current could be: (5V−4V)/0.033=30 Amps.

Thus, the calculated charging data 110 is indicative of the status of the charging and, on a broader scale, the efficiency of the power transfer cable 118. In one embodiment, the at least one charging data 110 includes: power transfer rate, an estimated recharge time, and a completed charge time of the battery 132. The power transfer rate indicates the amount of current passing through the battery 132 and the voltage generated at the battery 132 during recharging. The estimated charging time is a calculation of the estimated charging capacity of the battery 132 based on the current and voltage generated at the battery 132 during recharging. The completed charging time is a timing that utilizes an internal timer 128 to indicate the charging status of the battery 132, and consequently stops the timer at the moment that the battery 132 is fully charged. However, in other embodiments, additional types of charging data 110 may be derived and displayed for the battery 132.

The at least one charging data 110 is displayed through a plurality of displays 108a, 108b, 108c on the power adapter 100. The displays 108a-c may include a digital space that displays a number, and a progressive lighting system, such as a series of LED lights. A label panel 112 overlays the plurality of displays 108a-c. The label panel 112 is configured to identify each individual display accordingly. The label panel 112 comprises at least one label 116a, 116b, 116c that mark each display 108a-c according to the charging data 110. The label panel 112 also comprises a plurality of apertures 114a-c that enable viewing of the recharging data 110 from the underlying displays 108a-c.

For example, without limitation, an aperture 114a that enables viewing of the power transfer rate data has an adjacent Power Display marked on the label 116a. The aperture 114b that enables viewing of the completed charge time has an adjacent Time Display marked on the label 116b. The aperture 114c that enables viewing of the progressive lighting system for the estimated charging time has an adjacent Power Display by LED Lights marked on the label 116c. In this manner, the power transfer rate, the estimated recharge time, and the completed charging time are quickly identifiable. The capacity to identify the charging data 110 can be efficacious for selecting an efficient power transfer cable 118.

FIG. 1 references the power adapter 100 with recharge data display. The power adapter 100 is configured to enable recharging of a battery 132 on a communication device 138 and display at least one charging data 110 pertinent to the battery 132. The power adapter 100 is defined by a housing 102, a charging end 104, and a display end 106. The power adapter 100 may include a rectangular or circular shape. However, in other embodiments, any number of shapes and sizes may be used.

The housing 102 contains the components necessary to carry current, calculate recharging data 110, and display the recharging data 110. The charging end 104 includes an inlet terminal 134, such as a pair of power prongs that are configured to mate with a power source 130. A switch circuit 124 operatively connects to the inlet terminal 134 to regulate current from the power source 130. The housing 102 may also have an outlet terminal 136 that connects with a power transfer cable 118 that carries current form the power source 130 to the battery 132.

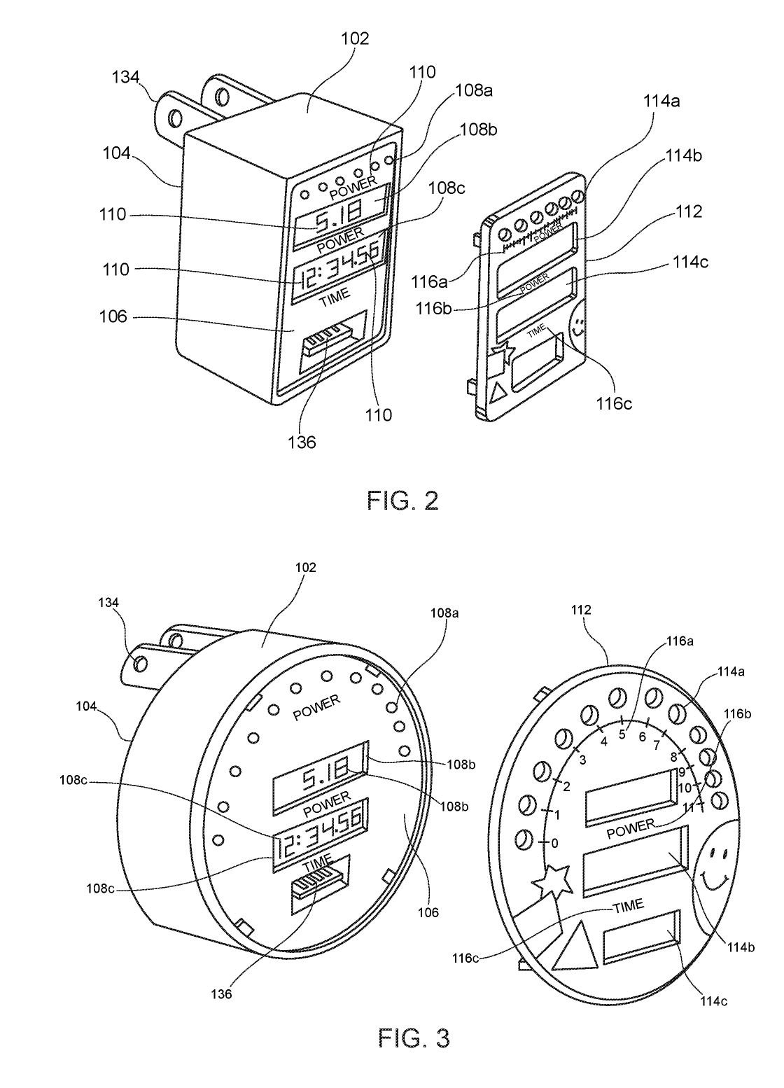

As shown in FIGS. 2 and 3, the power adapter 100 may include, without limitation, an AC/DC wall adapter, an AC adapter, an AC/DC convertor, a power charger, and the like. The power adapter 100 may operatively connect to the battery 132 in the communication device 138 through a power transfer cable 118. The power transfer cable 118 is configured to carry current from the charging end 104 of the power adapter 100 to the battery 132 for recharging. The power transfer cable 118 may include, without limitation, a USB cable with Type A terminal plugs (FIG. 1). The power adapter 100 is effective for determining the efficiency of the power transfer cable 118 by deriving and displaying the recharging data 110 associated with the power transfer cable 118. In one embodiment, the power transfer cable 118 is included with the power adapter 100. However in other embodiments, the power adapter 100 is universal, working with a variety of different power transfer cables 118.

The battery 132 may receive power for a predetermined period, and at a rate that is consistent with the power source 130 and the power adapter 100 supplying the power. The battery 132 may include, without limitation, a lithium polymer battery, a lithium ion battery, a nickel cadmium battery, and a nickel metal hybrid battery. The communication device 138 may include, without limitation, a smart phone, a tablet, a laptop, and an electrical device.

The current traveling through the battery 132 and voltage generated at the battery 132 is detected with a current detecting circuit 120 and a voltage detecting circuit 122. The current detecting circuit 120 is configured to detect a charging current during the recharging of the battery 132. The voltage detecting circuit 122 is configured to detect a charging voltage on the battery 132 during recharging.

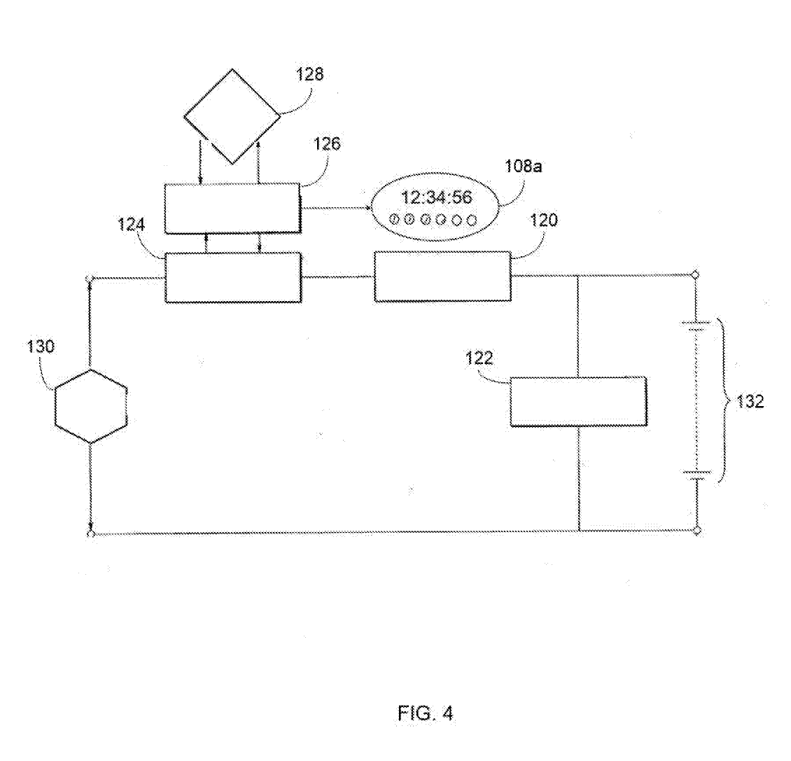

Turning now to FIG. 4, the power adapter 100 comprises a processor 126. The processor 126 may have circuitry, a timer 128, algorithms, microchips, and other components known in the art of processors 126. In one embodiment, the processor 126 is programmed with algorithm. The algorithm derives at least one charging data 110 based on the charging current and the charging voltage. In one embodiment, the algorithm reads the at least one charging data 110 and determines the amount of power being transferred through the power transfer cable 118. The processor may further comprise a timer 128. The timer 128 is configured to progressively indicate the rate of recharging and termination of recharging for the battery 132.

In some embodiments, the display end 106 of the housing 102 comprises a plurality of displays 108a-c. The displays 108a-c are configured to display the charging data 110. In some embodiments, the displays 108a-c may include a digital space that displays 108a-c a number, and a progressive lighting system, such as a series of LED lights. For example, the displays 108a-c may include, without limitation, a digital screen, a seven-segment display, a touch screen, a liquid crystal display, a progressive lighting system, and a series of LED lights. The digital screen display indicates electrical units and time, such as “kWh” to indicate charge capacity of the battery 132, “V” to indicate voltage, “Amps” to indicate current, and a timer 128 clock. The series of LED lights may include a progressive range of colors from green to red, whereby green indicates that the recharging is in process, and red indicates that the recharging is complete.

In one example of operation, the current detecting circuit 120 detects the charging current and supplies a detected signal for the charging current. The processor 126 actuates the timer 128 when the detected signal is received from the current detecting circuit 120. At the same time, the progressive lighting system display illuminates to indicate the beginning and continuation of the charging operation under control of the power adapter 100. For example, the progressive lighting system turns a green LED in an on-state. The timer 128 measures a predetermined time and supplies a charging completion signal for the processor 126 when the predetermined time lapses. The processor 126 turns the current detecting circuit 120 in response to the charging completion signal. Simultaneously, the processor 126 makes the progressive lighting system indicate a completion of the charge. For example, the progressive lighting system turns off the green LED or turns on a red LED.

In another example of operation, for determining the time required to recharge the battery 132, the power transfer cable 118 is inserted into the outlet terminal 136 of the housing 102. The algorithm reads and starts the timer 128 and displays the ongoing time on the digital screen display. When the recharge process is complete, the algorithm stops the timer 128 and the digital screen display stops changing times and displays the time at which the recharge was complete. Alternately, the algorithm, may read the recharge data from the communication device 138 or the power adapter 100 and display a countdown timer 128 on the digital screen display.

In some embodiments, the power adapter 100 may utilize a label panel 112. The label panel 112 is disposed to overlay the display end 106 of the power adapter 100. The label panel 112 may affix to the display end through various fastening means, including, without limitation, a magnet, a screw, frictional engagement, and an adhesive. The label panel 112 is defined by at least one label 116a-c. The at least one label 116a-c is configured to identify the at least one charging data 110. The label panel 112 further comprises a plurality of apertures 114a-c. The apertures 114a-c are configured to enable viewing of the at least one charging data 110. The apertures 114a-c are generally sized and dimensioned to match the shape of the corresponding display. Thus, each label 116a-c and adjacent aperture correlates with a respective charging data 110.

For example, without limitation, an aperture 114a that enables viewing of the power transfer rate data has an adjacent Power Display marked on the label 116a. The aperture 114b that enables viewing of the completed charge time has an adjacent Time Display marked on the label 116b. The aperture 114c that enables viewing of the progressive lighting system for the estimated charging time has an adjacent Power Display by LED Lights marked on the label 116c. In this manner, the power transfer rate, the estimated recharge time, and the completed charging time are quickly identifiable. The capacity to identify the charging data 110 can be efficacious for selecting an efficient power transfer cable 118.

Those skilled in the art will recognize that the power adapter 100 is effective for saving money because the power adapter 100 indicates whether the power transfer cable 118 is efficient or inefficient. In this manner, the optimal power transfer cable 118 can be selected for use. Furthermore, there is value for the time saved in utilizing the power adapter 100. The power adapter 100 may be bundled together with a high efficiency power transfer cable 118 when selling to the consumer market. This allows the immediate use of a qualified power rated power transfer cable 118 and immediate capability for efficient recharging.

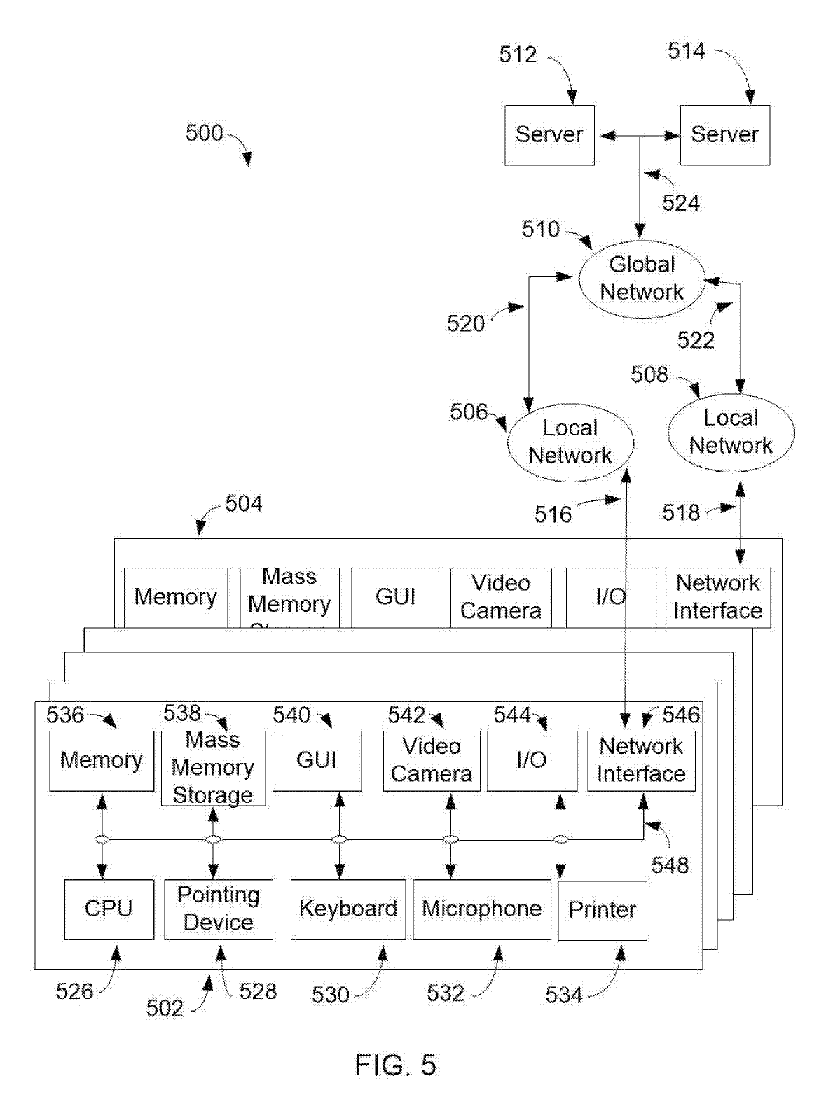

FIG. 5 is a block diagram depicting an exemplary client/server system which may be used by an exemplary web-enabled/networked embodiment of the present invention. A communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones. Client 502 includes a CPU 526, a pointing device 528, a keyboard 530, a microphone 532, a printer 534, a memory 536, a mass memory storage 538, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A power adapter with charging data display, the power adapter comprising:
a power adapter, the power adapter defined by a housing, the housing having a charging end and a display end, the power adapter configured to enable recharging;
a power transfer cable, the power transfer cable configured to connect to the charging end of the housing, the power transfer cable configured to carry current from the charging end of the housing for recharging;
a current detecting circuit, the current detecting circuit configured to enable detection of a charging current during recharging;
a voltage detecting circuit, the voltage detecting circuit configured to enable detection of a charging voltage during recharging;
a processor, the processor configured to derive at least one charging data based on the charging current and the charging voltage;
a plurality of displays, the plurality of displays disposed to position on the display end of the housing, the plurality of displays configured to display the at least one charging data; and
a label panel, the label panel disposed to at least partially overlay the display end of the housing and the plurality of displays, the label panel comprising at least one label, the at least one label configured to identify the at least one charging data on the plurality of displays, the label panel further comprising a plurality of apertures, the plurality of apertures configured to enable viewing of the at least one charging data,
wherein the at least one label correlates with a respective at least one charging data.

2. The power adapter of claim 1, wherein the power adapter is an AC/DC wall adapter.

3. The power adapter of claim 1, wherein the power adapter is generally rectangular or circular shaped.

4. The power adapter of claim 1, wherein the power transfer cable is a USB cord.

5. The power adapter of claim 1, wherein the power adapter recharges a battery on a communication device.

6. The power adapter of claim 5, wherein the battery includes at least one member selected from the group consisting of: a lithium polymer battery, a lithium ion battery, a nickel cadmium battery, and a nickel metal hybrid battery.

7. The power adapter of claim 1, further including a switch circuit, the switch circuit configured to regulate current from a power source.

8. The power adapter of claim 1, wherein the plurality of displays includes at least one member selected from the group consisting of: a digital screen, a seven-segment display, a touch screen, a liquid crystal display, a progressive lighting system, and a series of LED lights.

9. The power adapter of claim 1, wherein the plurality of apertures are configured to substantially match the shape of the plurality of displays.

10. The power adapter of claim 1, wherein the at least one charging data includes at least one member selected from the group consisting of: a power transfer rate, an estimated recharge time, and a completed charge time of the battery.

11. The power adapter of claim 1, wherein the processor comprises an algorithm, the algorithm configured to calculate the charging data based on the detected voltage signal and detected current signal.

12. The power adapter of claim 1, wherein the processor comprises a timer, the timer configured to progressively indicate the rate of recharging and termination time of recharging.

13. A power adapter with charging data display, the power adapter comprising:
a power adapter, the power adapter defined by a housing, the housing having a charging end and a display end, the power adapter configured to enable recharging;
a current detecting circuit, the current detecting circuit configured to detect a charging current during recharging;
a voltage detecting circuit, the voltage detecting circuit configured to detect a charging voltage during recharging;
a processor, the processor comprising an algorithm, the algorithm configured to derive at least one charging data based on the charging current and the charging voltage, the processor further comprising a timer, the timer configured to progressively indicate the rate of recharging and termination time of recharging;
a plurality of displays, the plurality of displays disposed to position on the display end of the housing, the plurality of displays configured to display the at least one charging data; and
a label panel, the label panel disposed to overlay the display end of the housing and the plurality of displays, the label panel comprising at least one label, the at least one label configured to identify the at least one charging data on the plurality of displays, the label panel further comprising a plurality of apertures, the plurality of apertures configured to enable viewing of the at least one charging data,
wherein the at least one label correlates with a respective at least one charging data.

14. The power adapter of claim 13, further including a switch circuit, the switch circuit configured to regulate current from a power source.

15. The power adapter of claim 13, wherein the power adapter is an AC/DC wall adapter.

16. The power adapter of claim 13, wherein the power adapter is generally rectangular or circular shaped.

17. The power adapter of claim 13, wherein the power transfer cable is a USB cord.

18. The power adapter of claim 13, wherein the plurality of apertures are configured to substantially match the shape of the plurality of displays.

19. The power adapter of claim 13, wherein the at least one charging data includes at least one member selected from the group consisting of: a power transfer rate, an estimated recharge time, and a completed charge time of the battery.

20. A power adapter with charging data display, the power adapter comprising:
a power adapter, the power adapter defined by a housing, the housing having a charging end and a display end, the power adapter configured to enable recharging;
a current detecting circuit, the current detecting circuit configured to detect a charging current during recharging;
a voltage detecting circuit, the voltage detecting circuit configured to detect a charging voltage during recharging;
a timer, the timer configured to progressively indicate a rate of recharging and a termination time of recharging;
a processor, the processor configured to derive at least one charging data based on the charging current and the charging voltage, the processor further configured to regulate the timer;
a plurality of displays, the plurality of displays disposed to position on the display end of the housing, the plurality of displays configured to display the at least one charging data;
a label panel, the label panel disposed to overlay the display end of the housing and the plurality of displays, the label panel comprising at least one label, the at least one label configured to identify the at least one charging data on the plurality of displays, the label panel further comprising a plurality of apertures, the plurality of apertures configured to enable viewing of the at least one charging data, wherein the at least one label correlates with a respective at least one charging data; and
a switch circuit, the switch circuit configured to enable regulation of a current from a power source.
